(19) United States
(12) Patent Application Publication
(10) Pub. No.: US 2013/0224617 A1
(43) Pub. Date: Aug. 29, 2013

(54) Coolant Circuit for a Fuel Cell System and Method for Changing out Ion Exchanger Material

(71) Applicants: Tom Haastert, Berlin (DE); Mario Mittmann, Owen (DE)

(72) Inventors: Tom Haastert, Berlin (DE); Mario Mittmann, Owen (DE)

(73) Assignee: Daimler AG, Stuttgart (DE)

(21) Appl. No.: 13/822,930

(22) PCT Filed: Nov. 4, 2011
(86) PCT No.: PCT/EP2011/005561

§ 371 Date: Mar. 13, 2013

(30) Foreign Application Priority Data
Nov. 13, 2010 (DE) 10 2010 051 346.6

(51) Int. Cl. H01M 8/04

(52) U.S. Cl. CPC H01M 8/04007
USPC 429/434

(57) ABSTRACT

A coolant circuit for a fuel cell system of a motor vehicle includes an ion exchanger material arranged in at least one component of the coolant circuit that is flowed through by coolant during the cooling operation. The ion exchanger material is fixed to an internal side of a wall of the at least one component. During an exchange of the ion exchanger material, the entire component is exchanged and replaced by a replacement component.

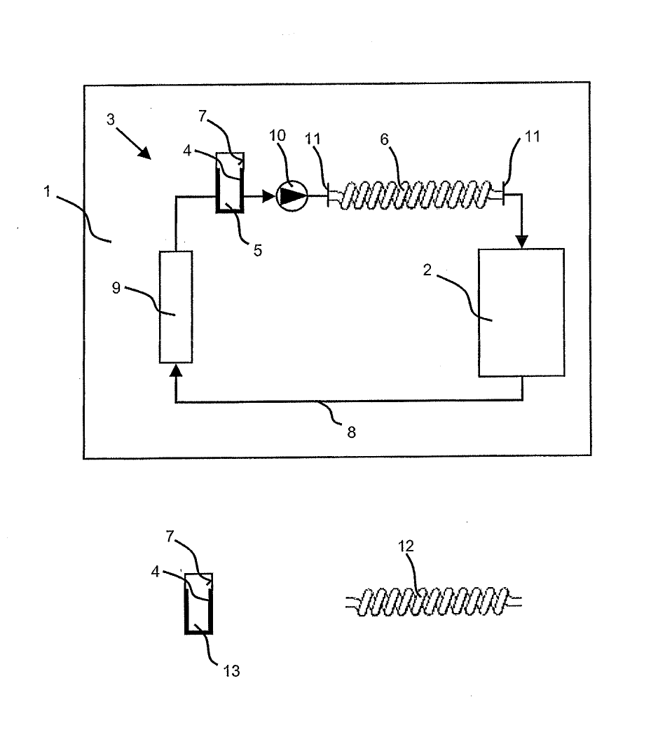

### BACKGROUND AND SUMMARY OF THE INVENTION

Exemplary embodiments of the present invention relate to a coolant circuit for a fuel cell system, in particular of a motor vehicle, having an ion exchanger material arranged in at least one component of the coolant circuit that is flowed through by coolant. Furthermore, the invention relates to a method for exchanging ion exchanger material in a coolant circuit for a fuel cell system.

German Patent Document DE 10 2009 012 379 A1 describes a coolant equalizing reservoir arranged in a coolant circuit for a fuel cell system of a vehicle. The coolant circuit serves to cool a fuel cell sequence of the fuel cell system. The coolant equalizing reservoir has an inlet and an outlet for the coolant. An ion exchange cartridge is inserted into the coolant reservoir and is in fluidic communication with the inlet. Coolant entering the coolant reservoir thus flows through the ion exchange cartridge and leaves it through the outlet window that is permeable for the coolant. The coolant, which is de-ionized by an ion exchange resin, then flows to the fuel cell sequence via the outlet of the coolant equalizing reservoir.

Japanese Patent Document JP 09019678 A1 discloses a cylindrical filter arranged in a coolant equalizing reservoir, which is fixed to the base and to the cap of the coolant equalizing reservoir. Coolant for a fuel cell system flows into the cylindrical internal space of the filter and is released by subjecting the filter to external materials such as particles and rust. The filtered coolant flows to a container with an ion exchanger material. The de-ionized coolant then arrives, via a supply line, at the component of the fuel cell system that is to be cooled.

In a coolant circuit of the type cited initially, exchanging the ion exchanger can be required comparatively often, since its ion exchange capacity is exhausted.

Exemplary embodiments of the present invention are directed to a coolant circuit and a method that provide a particularly long durability of the ion exchanger material.

In the coolant circuit according to the invention for a fuel cell system, an ion exchanger material is arranged in at least one of the components of the coolant circuit that is flowed through during cooling. The ion exchanger material is hereby fixed to an internal side of a wall of the at least one component. Due to this fixed integration of the ion exchanger material into the at least one component of the coolant circuit, it is not necessary for a cartouche or similar to be operated for exchanging the ion exchanger material, but rather the component is completely exchanged when the ion exchange capacity of the ion exchanger material is exhausted. A cartridge or cartouche containing the ion exchanger material can also be dispensed with. A particularly compact configuration of the components of the same can be achieved by such a cartridge-free design of the coolant circuit.

Contamination of the coolant while operating the ion exchanger material can be avoided to a particularly great extent if the component containing the ion exchanger material is completely replaced and not only the ion exchanger material itself. Due to the fact that no contamination reaches the coolant during exchange of the ion exchanger material, the ion exchange capacity of the ion exchanger material can be ensured over a particularly long period of time, such that a long durability of the ion exchanger material is provided.

In the immobilized present case of the same, the exchange of the ion exchanger material can take place in the at least one component in a clean manner, fast, and simple manner. Defects during the operation of the ion exchanger material can also be excluded to a particularly large extent. This enables a secure operation of the fuel cell system, which can be configured in particular for a mobile application in a vehicle. The coolant is conveyed through a live component, namely a fuel cell stack, in the vehicle with the fuel cell system. Thus, the coolant should have very low conductivity. In order to guarantee this, the ion exchanger material is present in the coolant circuit.

Advantages with respect to the weight of the coolant circuit and with respect to constructional space can also be produced, since the ion exchanger material is introduced into the coolant circuit by placing the component containing the ion exchanger material in the coolant circuit with the component at the same time. Since only a few interfaces in the coolant circuit need to be provided to remove the at least one component and to replace it with a replacement component, a particularly secure mounting and demounting of the ion exchanger material can be ensured. Furthermore, due to the good accessibility to the at least one component containing the ion exchanger material, service and maintenance operations can be carried out in a particularly simple manner.

Avoiding contaminations in the coolant results in saturation of the ion exchanger material occurring very slowly, which leads to particularly short maintenances times for a user of the coolant circuit. Indeed, contaminations in the coolant also lead to an increased conductivity of the same, which is to be avoided, since high conductivity in the coolant represents a safety risk. The coolant comes in contact with the fuel cell stack, which generates a comparatively high voltage during the use of the fuel cell system.

Fixing the ion exchanger material to the internal side of the wall of the at least one component thus enables a particularly clean operation of the ion exchanger material, which at best contributes to a very low level of pollution being inserted into the coolant.

The ion exchanger material can be applied to the internal side of the walls of all components of the coolant circuit, in order to provide a particularly large reactive surface of the ion exchanger material. However, it is preferred for the ion exchanger material to be present only in a subdomain of the coolant circuit.

Thus, according to an advantageous embodiment of the invention, the ion exchanger material can be fixed to the internal side of the wall of a coolant equalizing reservoir and/or to the internal side of the wall of a line section of the coolant circuit. Then, during maintenance, only the coolant equalizing reservoir or the line section are to be exchanged, so as to provide an unconsumed ion exchanger material that is still unsaturated in the coolant circuit. The coolant equalizing reservoir or the line section are preferably components that have particularly good accessibility.

It has been shown to be particularly advantageous if the line section is designed as a helix. Such a section of the coolant circuit that is designed in the shape of a cylindrical spiral enables highly intensive contact between the coolant and the coolant exchanger material to be guaranteed even in very constricted constructional space conditions. Adjusting the available constructional space can be carried out by adjusting the number and/or diameter of the individual loops of the helix and/or by providing a gap, particularly a variable gap, between the individual coils, as well as by adjusting their geometrical shape. The helix or ion exchanger coil can hereby be formed from a pipeline and/or from a flexible hose assembly. Instead of a helix, other constructional forms are also suitable, which guarantee highly intensive contact between the coolant and the coolant exchanger material, such as a coiled pipe (i.e. a meandering pipe section with several inversions in the flow direction one after the other) or a device in the form of a plate heat exchanger (i.e. a pipe section wherein the flow is channeled repeatedly against flow resistance, such as deflector plates).

In a further advantageous embodiment of the invention, the ion exchanger material is designed as a coating applied to the internal side of the wall of the at least one component. Thus, a low level of flow resistance of the components being flowed through is achieved by particularly extensive removal of ions from the coolant at the same time. It can, however, also be the case that the ion exchanger material completely fills the cross-section of the at least one component that can be flowed through, such that, during the cooling operation, particularly intensive contact between the coolant and the ion exchanger material is provided.

A particularly extensive immobilization of the ion exchanger material by its being fixed to the internal wall of the component can be achieved if the ion exchanger material is connected to the wall of the component by at least partial fusion of the component. This can already take place advantageously during the production of the component.

Additionally or alternatively, the ion exchanger material can be affixed onto the internal side of the wall of the component. Also, in this way, a damage-free, permanent connection of the ion exchanger material to the internal wall can be achieved. The ion exchanger material can also be fastened to the internal side of the wall of the component in a different manner, so can be, for example, connected, riveted, locked, pressed or suchlike. However, it is particularly preferable if the ion exchanger material is affixed.

In an additional or alternative embodiment, the ion exchanger material can be equipped with reactive chemical groups—so-called “anchor groups”—which can react chemically with corresponding reactive chemical groups on the internal side of the wall of the component. For this, the component can be chemically modified in advance in its internal side, in order to provide the reactive chemical groups at the wall. By bringing the ion exchanger material into contact with the chemically modified internal wall of the component and by having the anchor groups of the ion exchanger material chemically vented off with the corresponding reactive chemical groups of the internal wall, a fixed, chemical anchoring or immobilizing of the ion exchanger material to the internal wall of the component can take place, which is particularly accessible. This chemical anchoring or immobilizing can furthermore be carried out in a particularly cost-effective manner by introducing the ion exchanger material into the component.

Alternatively, one or more pouches can also be applied to the internal side of the wall of the component, into which the ion exchanger material is introduced in the form of a filler. The pouches are designed in such a way that they are permeable for the coolant but impermeable for the ion exchanger material. The pouches can be releasably connected to the internal wall, e.g. by click or latch locking mechanisms, or unreleasably, e.g. by bonding.

It has also been shown to be advantageous if the wall of the component containing the ion exchange material is designed at least in some regions as being transparent. In this way, the status of the ion exchange material can be monitored and controlled in a particularly simple manner.

Finally, it has been shown to be advantageous if the coolant circuit has at least one locking element, which, during the removal of the component containing the ion exchanger material from the coolant circuit, is set up in such a way as to eliminate coolant escaping from a connection of the component and/or from a further component coupled to the component. Also, in this manner, the introduction of contaminations into the coolant can be eliminated to a particularly great extent. Also, in this way, loss of coolant during mounting or demounting of the component containing the ion exchanger material can be kept at a particularly low level. The locking element provided at the connection of the component or at the connection of the further component coupled to the component can be set up for automatic elimination of coolant escape, such that the connections are sealed when the components are coupled.

The connections can comprise latch elements and/or screw threads or can be designed as a bayonet lock, in order to enable a particularly simple and secure demounting of the component containing the ion exchanger material and a mounting of a replacement component. Also, the connection can comprise a sealing element in order to achieve a tight coupling of the component containing the ion exchanger material to the further component. A filter can be provided to eliminate discharge of ion exchanger material from the component.

Due to particularly small cross-sections at the coupling points of the removed component or the replacement component to both adjacent components, introduction of contaminations into the coolant can also be kept at a particularly low level.

For the method according to the invention for exchanging ion exchanger material in a coolant circuit for a fuel cell system, in particular of a vehicle, at least one component that is flowed through by coolant during the cooling operation and is fluidically coupled to two adjacent components is removed from the coolant circuit. This removed component contains the ion exchanger material. By removing the at least one component, the coolant circuit is fluidically disconnected. Then the removed component is replaced by a replacement component containing ion exchanger material, wherein the fluidic coupling of the coolant circuit is reproduced by this replacement. Due to the fact that the entire component is replaced by the replacement component, and not only the ion exchanger material contained in the replacement component, a particularly dirt-free, clean contact with the ion exchanger material can be ensured, which prevents an introduction of contaminations into the coolant. This results in a particularly long durability of the ion exchanger material and limitations to the fuel cell system, in particular while driving, are reduced. The replacement component is set up in such a way that it is compatible with the removed component.

The replacement component contains the ion exchanger material in a state in which this has lower ion saturation than the removed component.

If the replacement component is delivered in a protective sleeve, the possibility of contact with the coolant during the operation of the replacement component can additionally be reduced to a particularly extensive degree.

The replacement component can contain the ion exchanger material as a bulk good and/or in fixed form on an internal side of a wall of the replacement component. Alternatively, a cartouche containing the ion exchanger material can be inserted into the replacement component, such that the cartouche, together with the replacement component, replaces the previous ion exchanger material.

The advantages and preferred embodiments described for the coolant circuit according to the invention are also valid for the method according to the invention, and vice versa.

The features and feature combinations cited in the description above and below in the description of the figures and/or shown in the figure alone can be used not only in each specified combination, but rather also in other combinations or individually, without exceeding the scope of the invention.

### BRIEF DESCRIPTION OF THE DRAWING FIGURE

Further advantages, features and details of the invention arise from the claims, the description of preferred embodiments below and with the aid of the FIGURE.

The sole FIGURE schematically illustrates a vehicle with a coolant circuit for cooling a fuel cell stack and replacement components of the coolant circuit.

### DETAILED DESCRIPTION

A vehicle 1 shown in the figure has a fuel cell stack 2, which provides electrical energy for driving the vehicle 1. A coolant circuit 3 is provided for cooling the fuel cell stack 2. Coolant that flows through the coolant circuit 3 must, to a great extent, be ion-free, since the coolant during the cooling operation is in contact with live components of the fuel cell system, such as the fuel cell stack 2.

In order to ensure the lack of ions in the coolant circuit, an ion exchanger material 4 is present in the coolant circuit 3, which absorbs ions contained in the coolant until its ion exchanger capacity is exhausted. The ion exchanger material 4 is tightly integrated in components of the coolant circuit 3, namely into a coolant equalizing reservoir 5 and a coiled tube 6. Here, the ion exchanger material 4 is arranged to be immobilized, namely in the form of a coating applied to an internal side 7 of a wall of the component.

If the ion exchanger material 4 cannot absorb further ions from the coolant, the entire component of the coolant circuit 3, so the coolant equalizing reservoir 5 or the coiled tube 6, is exchanged. Thus, the risk of an introduction of contaminations into the coolant can be kept at a very low level, which is different from what would be the case if an ion exchange cartridge were removed from the coolant equalizing reservoir 5 and replaced by an unconsumed cartridge.

In alternative embodiments, the entire coolant circuit 3 can also be covered on its internal side with the ion exchanger material 4, so, for example, lines 8, which connect the fuel cell stack 2 to a cooler 9 and a pump 10, as well as the cooler 9 itself. Alternatively, only the coolant equalizing reservoir 5 or the coiled tube 6 can also have the ion exchanger material 4, which is fixed to the internal side 7 of the wall of the respective component.

If only the coiled tube 6—as an example for a partial section of the coolant circuit 3—has the ion exchanger material in fixed form on the internal side of the wall, only the coiled tube 6 needs to be removed from the coolant circuit 3 for exchanging the ion exchanger material and replaced by a replacement coiled tube 12 with still unconsumed ion exchanger material.

The coiled tube 6 can be adjusted particularly well to the constructional space conditions present for accommodating the coolant circuit 3 in the vehicle 1 by varying the number of its coils as well as their diameter and distance from one another, and moreover by adjusting their geometrical shape. In addition, the coolant is in intensive contact with the internal side of the wall covering the ion exchanger material when the coiled tube 6 is being flowed through, such that a particularly extensive de-ionization of the coolant can be achieved by means of the coiled tube 6.

In order to achieve immobilization of the ion exchanger material 4 on the internal side 7 of the wall of the component of the coolant circuit 3, the ion exchanger material 4 can be fused into the wall, for example when the coolant equalizing reservoir 5 or the coiled tube 6 is produced. Fixing the ion exchanger material 4 to the internal side 7 of the wall can, however, also take place by affixing or by chemical anchoring. For this, a corresponding chemical pre-treatment of the wall of the partial section of the coolant circuit 3 that is to be added to the ion exchanger material 4 can be provided on at least its internal side 7.

The coiled tube 6 with adjacent sections of the line 8 of the coolant circuit 3 is coupled by means of connections 11. These connections 11 are preferably designed to be self-sealing, such that, during a removal of the coiled tube 6 from the coolant circuit 3, no coolant can escape from the now-fluidically disconnected coolant circuit 3. In addition, no dirt can infiltrate the coolant via the automatically sealing connections 11, which is located in the disconnected coolant circuit 3.

During the subsequent assembly of the replacement coiled tube 12, this only needs to be connected to the adjacent partial sections of the line 8 of the coolant circuit 3 via the connections 11, in order to reproduce the fluidic coupling of the coolant circuit 3. A defective mounting of the replacement coiled tube 12 can be prevented by a controlled, positively engaging design of the connections 11, which, for example, enables a latching, bolting or clipping of the replacement coiled tube 12 into the coolant circuit 3. The lines 8, which are only shown schematically in the figure, have at least essentially the same permeable cross-section, at least in the region of the connections 11, as the coiled tube 6.

If the coolant equalizing reservoir 5 alone is to contain the ion exchanger material 4, thereby making an exchange of the ion exchanger material 4 and a replacement of the coolant equalizing reservoir 5 necessary, it is also advantageous to design the coupling points of the coolant equalizing reservoir 5 to the adjacent partial sections of the line 8 in the manner of self-sealing quick-fasteners, so analogously to the connections 11 for the coiled tube 6.

For the exchange of the ion exchanger material 4, the coolant equalizing reservoir 5 that is coupled fluidically to the coolant circuit 3 is removed and thus the coolant circuit 3 is fluidically disconnected. Then the entire coolant equalizing reservoir 5 is replaced by a replacement reservoir 13 with still-unconsumed ion exchanger material 4 whose ion exchange capacity is not yet exhausted on the internal side 7 of its walls. By inserting the replacement reservoir 13 into the coolant circuit 3, the fluidic coupling of the same is reproduced.

Due to the fact that a clean mounting and demounting of the ion exchanger material 4, which prevents an introduction of ions into the coolant, can be guaranteed, it is possible to achieve a particularly long durability of the ion exchanger material 4, and the coolant can be used over a long period of time without jeopardizing the cooling of the fuel cell stack 2 of the vehicle 1.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### List of Reference Numerals

1 Vehicle
2 Fuel cell stack
3 Coolant circuit
4 Ion exchanger material
5 Coolant equalizing reservoir
6 Coiled tube
7 Internal side
8 Line
9 Cooler
10 Pump
11 Connection
12 Replacement coiled tube
13 Replacement reservoir

1-11. (canceled)

12. A coolant circuit for a fuel cell system of a vehicle, comprising:
at least one component of the coolant circuit that is configured to be flowed through by coolant during the cooling operation; and
an ion exchanger material arranged in the at least component, wherein the ion exchanger material is fixed to an internal side of a wall of the at least one component.

13. The coolant circuit according to claim 12, wherein the at least one component is a coolant equalizing reservoir or a line section of the coolant circuit.

14. The coolant circuit according to claim 13, wherein the line section has a helical shape.

15. The coolant circuit according to claim 12, wherein the ion exchanger material is a coating applied to the internal side of the wall of the at least one component.

16. The coolant circuit according to claim 12, wherein the ion exchanger material is connected to the wall of the at least one component by at least partial fusion of the at least one component.

17. The coolant circuit according to claim 12, wherein the ion exchanger material is fastened to the internal side of the wall of the at least one component by being affixed, connected, riveted, locked, or pressed.

18. The coolant circuit according to claim 12, wherein the ion exchanger material is equipped with reactive chemical groups, which react chemically with corresponding reactive chemical groups on the internal side of the wall of the at least one component, such that the ion exchanger material is chemically anchored to the internal side of the wall of the at least one component.

19. The coolant circuit according to claim 12, wherein the internal side of the wall of the component has one or more pouches that are permeable for coolant and impermeable for ion exchanger material, into which the ion exchanger material is inserted in the form of a filler.

20. The coolant circuit according to claim 12, wherein the wall of the at least one component containing the ion exchanger material is transparent in at least some regions.

21. The coolant circuit according to claim 12, further comprising:
at least one locking element configured so that during removal of the at least one component from the coolant circuit coolant escape is eliminated from a connection of the at least one component or from a further component coupled to the at least one component.

22. A method for exchanging ion exchanger material in a coolant circuit for a fuel cell system of a vehicle, comprising:
removing, from the coolant circuit, at least one component that is flowed through by coolant during cooling operation and that is fluidically coupled to two adjacent components, wherein the coolant circuit includes an ion exchanger material, wherein the coolant circuit is fluidically disconnected by the removal of the at least one component; and
replacing the removed at least one component with a replacement component containing an ion exchanger material, wherein the fluidic coupling of the coolant circuit is reproduced by the replacement component.
